(19) United States
(12) Patent Application Publication
(10) Pub. No.: US 2014/0168437 A1
(43) Pub. Date: Jun. 19, 2014

(54) VEHICLE CAMERA AND DOOR SWITCH ASSEMBLY

(71) Applicant: MAGNA ELECTRONICS INC., Auburn Hills, MI (US)

(72) Inventors: Marc Rother, Munchen (DE); Joern Ihlenburg, Berlin (DE)

(73) Assignee: MAGNA ELECTRONICS INC., Auburn Hills, MI (US)

(21) Appl. No.: 14/102,980

(22) Filed: Dec. 11, 2013

Related U.S. Application Data
(60) Provisional application No. 61/736,103, filed on Dec. 12, 2012.

(51) Int. Cl. B60R 1/00

(52) U.S. Cl. CPC B60R 1/00
USPC 348/148

(57) ABSTRACT

A camera and switch assembly for a vehicular vision system includes a housing, a circuit board, an image sensor disposed at the circuit board, a handle switch disposed at the housing and circuitry disposed at the circuit board. The circuitry includes sensor circuitry that is associated with the image sensor and switch circuitry that is associated with the handle switch. The housing is configured for attachment at a door of a vehicle. The handle switch is operable to actuate a latch of the door of the vehicle when actuated by a user. A vehicle wire is electrically connected to the sensor circuitry associated with the image sensor and to the switch circuitry associated with the handle switch.

### CROSS REFERENCE TO RELATED APPLICATION

The present application claims the filing benefits of U.S. provisional application Ser. No. 61/736,103, filed Dec. 12, 2012, which is hereby incorporated herein by reference in its entirety.

### FIELD OF THE INVENTION

The present invention relates to vehicles with cameras mounted thereon and in particular to vehicles with exterior-facing cameras, such as forward facing cameras and/or sideward facing cameras and/or rearward facing cameras.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a camera for a vision system that utilizes one or more cameras or image sensors to capture image data of a scene exterior (such as forwardly) of a vehicle and provides a display of images indicative of or representative of the captured image data. The imager or camera includes a circuit board at which one or more components and/or circuitry is/are established.

The present invention provides a combined grip handle or handle switch and a rear vehicle camera (RVC) assembly for use at a rear of a vehicle. An all rear cover of the RVC may be a pocket of the grip handle. All the alignment may be handled in the lens holder of the RVC. A flexible connection to the outside is provided. Thus, a unitary or modular construction of a camera and handle switch may be provided that may be installed as a unit on a vehicle. The unitary module or unit may comprise a substantially sealed and substantially waterproof or water impervious module or unit. Optionally, a waterproof or water impervious switch for the trunk opening signal may be added. The present invention may provide high cost saving opportunities in terms of bill of materials (BOM), part numbers handling and assembly time for the OEM. The savings may even be greater if there is only one connector needed at the rear side of the grip handle for both the RVC and grip handle wires.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a side perspective view of a camera assembly of the present invention;

FIG. 3 is a rear side perspective view of the camera assembly of FIG. 2;

FIG. 4 is a front perspective view of the camera assembly of FIG. 2, shown with a front plate with a hatch handle switch and camera lens in accordance with the present invention;

FIG. 5 is a front view of the housing of the vehicle rear camera and switch assembly of the present invention;

FIG. 6 is a rear view of the camera and switch assembly of the present invention;

FIG. 7 is a perspective view of the camera and switch assembly of the present invention;

FIG. 8 is an exploded view of a camera assembly;

FIG. 9 is an enlarged exploded view of the camera and lens and cover assembly of the camera assembly of FIG. 8;

FIG. 10 is an enlarged perspective view of the camera and lens and cover assembly of FIG. 8; and

FIG. 11 is an block diagram of a PCB with the door handle switch circuits and camera electronics circuits disposed thereat or integrated therewith, and having the power supply and control and the bus interface circuits commonly disposed at or established on the PCB in accordance with the present invention.

### LEGEND

20 Housing.
21 Connector structure.
22 Connector Pins.
23 Outlet/Window for Camera Lens Structure.
24 Outlet/Window for Hatch Handle Switch.
25 Front Plate.
26 Camera Lens Structure.
27 Hatch Handle Switch.

### DETAILED DESCRIPTION OF THE INVENTION

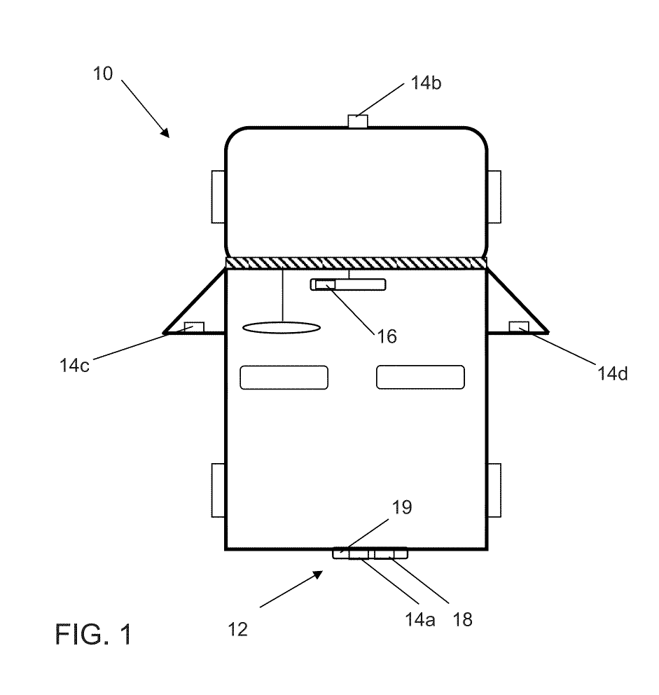

Referring now to the drawings and the illustrative embodiments depicted therein, a vehicle 10 includes an imaging system or vision system 12 that includes one or more imaging sensors or cameras (such as a rearward facing imaging sensor or camera 14a and/or a forwardly facing camera 14b at the front (or at the windshield) of the vehicle, and/or a sidewardly/rearwardly facing camera 14c, 14b at the sides of the vehicle), which capture images exterior of the vehicle, with the cameras having a lens for focusing images at or onto an imaging array or imaging plane of the camera (FIG. 1). The vision system 12 is operable to process image data captured by the cameras and may provide displayed images at a display device 16 for viewing by the driver of the vehicle. Optionally, the vision system may process image data to detect objects, such as objects to the rear of the subject or equipped vehicle during a reversing maneuver, or such as approaching or following vehicles or vehicles at a side lane adjacent to the subject or equipped vehicle or the like. A rear hatch or door release switch 18 is disposed at the rear of the vehicle for opening the rear hatch or door of the vehicle. The camera and rear switch are incorporated in a single housing or module 19 that is mounted at the rear portion of the vehicle, as discussed below.

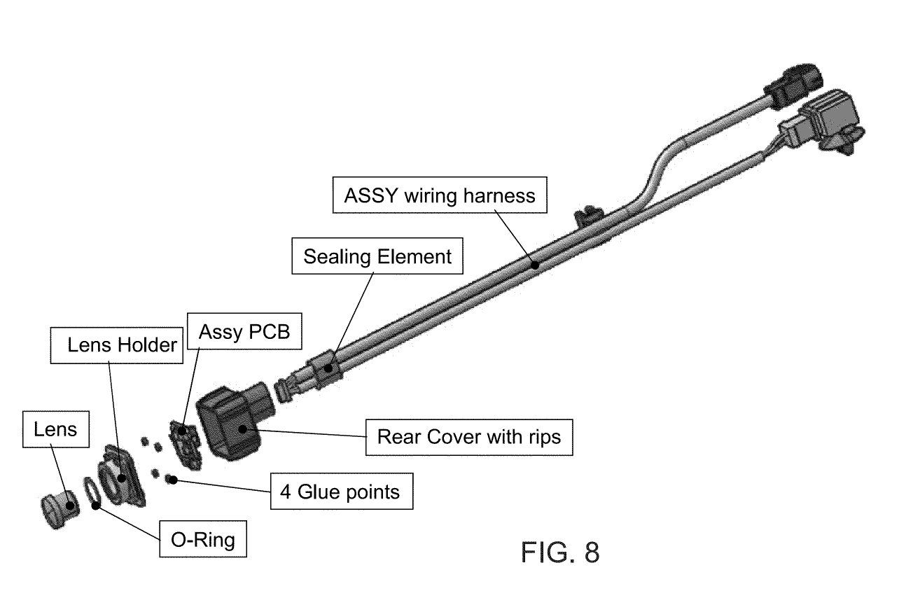

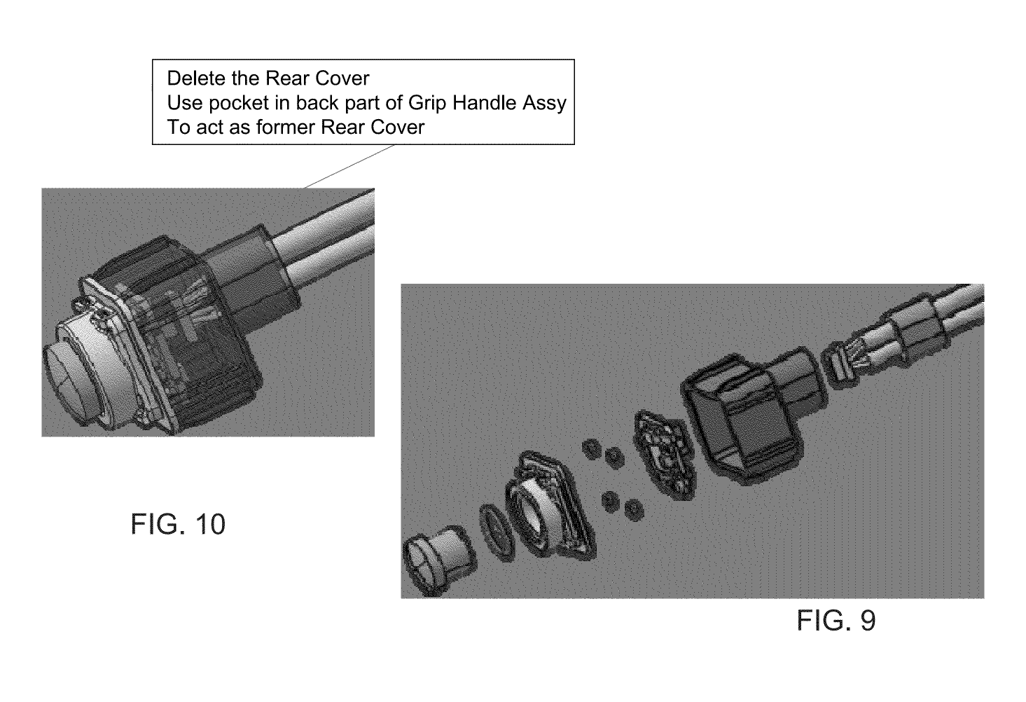

Automotive vehicle rear cameras and hatch/trunk handle switches are typically placed in direct neighborhood to each other. Also, the license plate illumination is often to be found there. Typically, a fully assembled camera (having a housing), such as shown in FIGS. 8-10, is integrated into a slot that is established at a common structure which also bears the hatch's switch. Both parts (the switch and the camera) have their own separate connector and wire harness. Typically, the switch has no bus but just a two wire closing contact. The door handle piece may be shipped to the camera assembly plant or facility and both pieces may be united or married there and then the full assembly may be shipped to the vehicle assembly plant. This means the handle is shipped two times.

The present invention combines the housing for the door handle with a camera housing so these are unitary construction or modular construction or one piece. Instead of having two connector structures and two connectors with sealings on the wire harness, there is just one of each. The visible (scratch sensitive) front plate may be produced and handled separately. It is combined with the camera and door handle housing before the end of line test at the camera assembly line. The OEM or vehicle manufacturer will then receive the whole assembly in one piece. The camera housing may be the same (a common or universal camera housing) when the front plate design is adapted to different vehicle design types. The present invention thus provides a cost reduction in logistics, wire harnesses and connectors and eliminates one housing (by providing one bigger housing instead of two small ones).

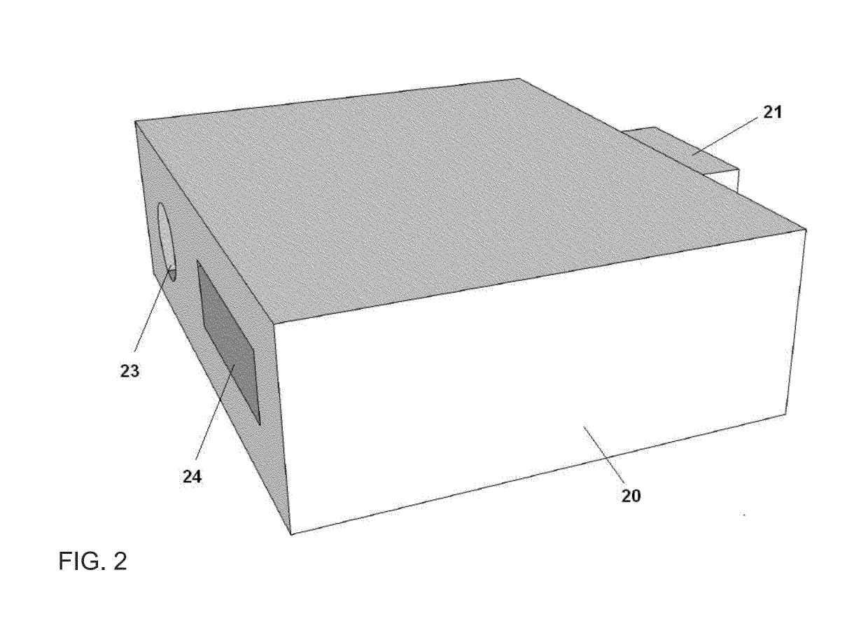

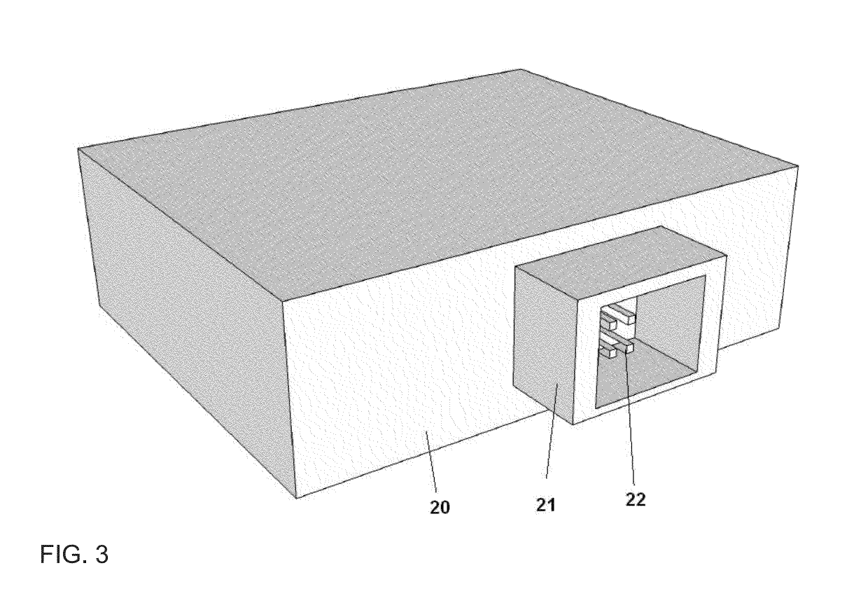

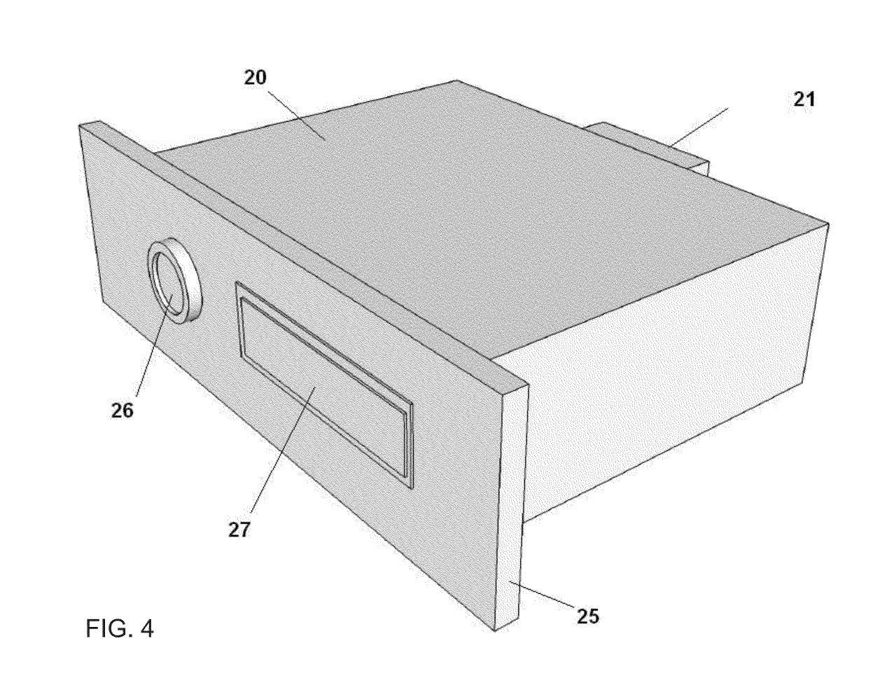

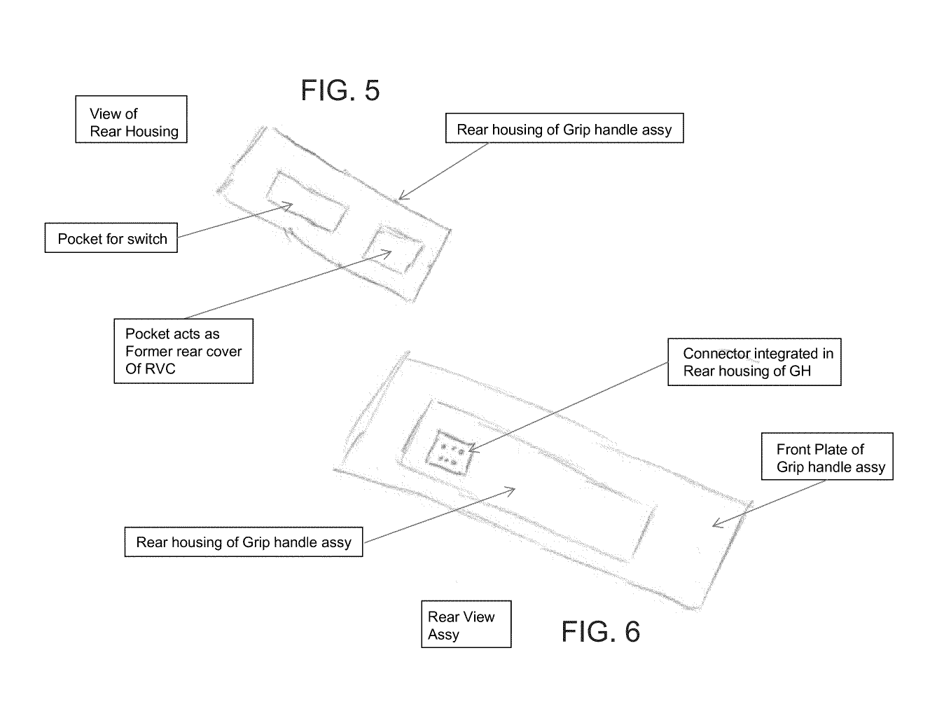

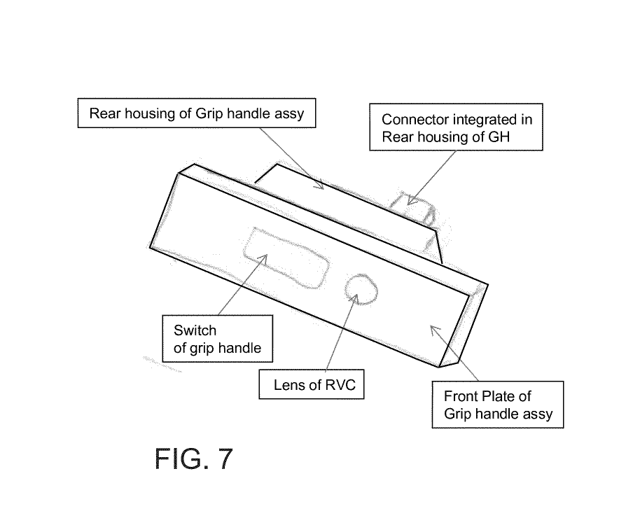

For example, and with reference to FIGS. 2-7, the camera and hatch release switch module 19 includes a housing 20 that houses the camera circuitry and hatch handle switch circuitry and that includes a connector or connector structure 21, such as a multi-pin connector having a plurality of connector pins 22 or the like disposed at a rear wall or portion of the housing. The housing 20 includes an outlet/window 23 for a camera lens structure 26, and includes an outlet/window 24 for a hatch handle switch 27. As shown in FIG. 4, a front plate 25 is disposed at the front of the housing 20, whereby the camera lens structure 26 and the hatch handle switch 27 are disposed at the front plate. The camera and hatch handle switch assembly may be mounted at a vehicle as a unit or module and a single wiring harness of the vehicle may electrically connect at the connector 21 to electrically power and/or control the camera and/or hatch handle switch.

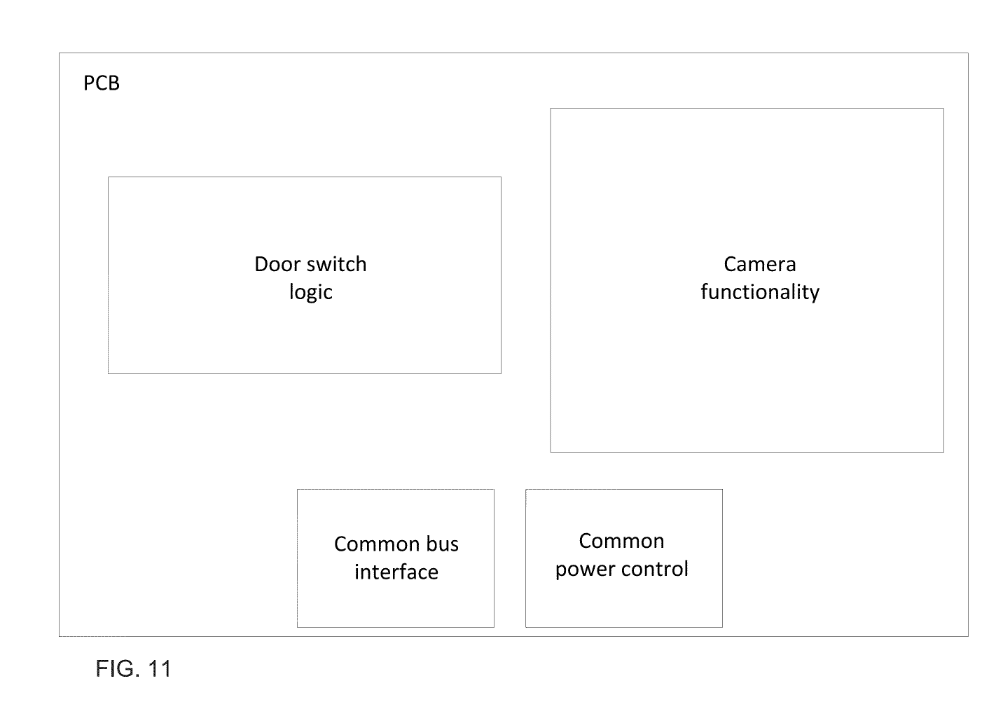

Thus, the present invention provides a unitary housing or module or unit that includes both a rear vision camera or backup camera and a rear door hatch release switch. The door handle contacts may be attached to or established at or disposed at the camera PCB (see, for example, FIG. 11). The door handle contact signal may be transmitted via a (common) bus interface and/or common data line that is already part of the camera or camera assembly. Optionally, a vehicle license plate illumination or light source may also be integrated into the camera module or housing, including an LED (light emitting diode) driver and fail diagnosis functionality. Optionally, the vehicle license plate illumination wiring may be connected to the housing over a cable tail coming from the housing or a second plug. Optionally, the power supply and control for the camera, the handle switch and any optional illumination may also be commonly comprised at or established at or disposed at a common PCB, such as can be seen with reference to FIG. 11. The front plate may be clipped, screwed, welded, glued, calked or riveted onto the housing, with the lens structure and hatch handle switch disposed thereat. The cable anchorage(s) may be part of the housing's structure. The housing may be made of a metal or plastic material or the like. The housing, wire harness and PCB may be made or configured in a way that it suits or fits a high variant or vehicle build or model level (such as an upscale model of a vehicle) with camera and handle switch and optional other functionality and a low variant or vehicle build or model level (such as a baseline vehicle) with the camera functionality not included.

Optionally, the common system's housing, bus, power supply and control may also comprise a second rear camera, a LIDAR, a time of flight (TOF) sensor, a structure light emitter or RADAR or the like. Optionally, the common system's housing, bus, power supply and control may also comprise a Laser for projecting warning and/or distance marker information at or towards or to the rear ground.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, an array of a plurality of photosensor elements arranged in at least 640 columns and 480 rows (preferably a megapixel imaging array or the like), with a respective lens focusing images onto respective portions of the array. The photosensor array may comprise a plurality of photosensor elements arranged in a photosensor array having rows and columns. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/103193; WO 2012/0116043; WO 2012/0145501; WO 2012/0145343; WO 2012/154919; WO 2013/019707; WO 2013/016409; WO 2012/145822; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661 and/or WO 2013/158592 and/or U.S. patent application Ser. No. 14/082,573, filed Nov. 18, 2013 (Attorney Docket MAG04 P2183); Ser. No. 14/082,574, filed Nov. 18, 2013 (Attorney Docket MAG04 P2184); Ser. No. 14/082,575, filed Nov. 18, 2013 (Attorney Docket MAG04 P2185); Ser. No. 14/082,577, filed Nov. 18, 2013 (Attorney Docket MAG04 P2203); Ser. No. 14/071,086, filed Nov. 4, 2013 (Attorney Docket MAG04 P2208); Ser. No. 14/076,524, filed Nov. 11, 2013 (Attorney Docket MAG04 P2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional Applications, Ser. No. 61/901,127, filed Nov. 7, 2013; Ser. No. 61/905,461, filed Nov. 18, 2013; Ser. No. 61/905,462, filed Nov. 18, 2013; Ser. No. 61/895,610, filed Oct. 25, 2013; Ser. No. 61/895,609, filed Oct. 25, 2013; Ser. No. 61/893,489, filed Oct. 21, 2013; Ser. No. 61/886,883, filed Oct. 4, 2013; Ser. No. 61/879,837, filed Sep. 19, 2013; Ser. No. 61/879,835, filed Sep. 19, 2013; Ser. No. 61/878,877, filed Sep. 17, 2013; Ser. No. 61/875,351, filed Sep. 9, 2013; Ser. No. 61/869,195, filed. Aug. 23, 2013; Ser. No. 61/864,835, filed Aug. 12, 2013; Ser. No. 61/864,836, filed Aug. 12, 2013; Ser. No. 61/864,837, filed Aug. 12, 2013; Ser. No. 61/864,838, filed Aug. 12, 2013; Ser. No. 61/856,843, filed Jul. 22, 2013, Ser. No. 61/845,061, filed Jul. 11, 2013; Ser. No. 61/844,630, filed Jul. 10, 2013; Ser. No. 61/844,173, filed Jul. 9, 2013; Ser. No. 61/844,171, filed Jul. 9, 2013; Ser. No. 61/842,644, filed Jul. 3, 2013; Ser. No. 61/840,542, filed Jun. 28, 2013; Ser. No. 61/838,619, filed Jun. 24, 2013; Ser. No. 61/838,621, filed Jun. 24, 2013; Ser. No. 61/837,955, filed Jun. 21, 2013; Ser. No. 61/836,900, filed Jun. 19, 2013; Ser. No. 61/836,380, filed Jun. 18, 2013; Ser. No. 61/834,129, filed Jun. 12, 2013; Ser. No. 61/833,080, filed Jun. 10, 2013; Ser. No. 61/830,375, filed Jun. 3, 2013; Ser. No. 61/830,377, filed Jun. 3, 2013; Ser. No. 61/825,752, filed May 21, 2013; Ser. No. 61/825,753, filed May 21, 2013; Ser. No. 61/823,648, filed May 15, 2013; Ser. No. 61/823,644, filed May 15, 2013; Ser. No. 61/821,922, filed May 10, 2013; Ser. No. 61/819,835, filed May 6, 2013; Ser. No. 61/819,033, filed May 3, 2013; Ser. No. 61/816,956, filed Apr. 29, 2013; Ser. No. 61/815,044, filed Apr. 23, 2013; Ser. No. 61/814,533, filed Apr. 22, 2013; Ser. No. 61/813,361, filed Apr. 18, 2013; Ser. No. 61/810,407, filed Apr. 10, 2013; Ser. No. 61/808,930, filed Apr. 5, 2013; Ser. No. 61/807,050, filed Apr. 1, 2013; Ser. No. 61/806,674, filed Mar. 29, 2013; Ser. No. 61/793,592, filed Mar. 15, 2013; Ser. No. 61/772,015, filed Mar. 4, 2013; Ser. No. 61/772,014, filed Mar. 4, 2013; Ser. No. 61/770,051, filed Feb. 27, 2013; Ser. No. 61/770,048, filed Feb. 27, 2013; Ser. No. 61/766,883, filed Feb. 20, 2013; Ser. No. 61/760,366, filed Feb. 4, 2013; Ser. No. 61/760,364, filed Feb. 4, 2013; Ser. No. 61/756,832, filed Jan. 25, 2013; Ser. No. 61/754,804, filed Jan. 21, 2013; Ser. No. 61/736,104, filed Dec. 12, 2012; Ser. No. 61/736,103, filed Dec. 12, 2012; Ser. No. 61/734,457, filed Dec. 7, 2012; Ser. No. 61/733,598, filed Dec. 5, 2012; and/or Ser. No. 61/733,093, filed Dec. 4, 2012, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,123,168; 7,004,606; 6,946,978; 7,038,577; 6,353,392; 6,320,176; 6,313,454; and 6,824,281, and/or International Publication No. WO 2010/099416, published Sep. 2, 2010, and/or PCT Application No. PCT/US10/47256, filed Aug. 31, 2010 and published Mar. 10, 2011 as International Publication No. WO 2011/028686, and/or U.S. patent application Ser. No. 12/508,840, filed Jul. 24, 2009, and published Jan. 28, 2010 as U.S. Pat. Publication No. US 2010-0020170, and/or PCT Application No. PCT/US2012/048110, filed Jul. 25, 2012 (Attorney Docket MAG04 FP-1907(PCT)), and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. patent application Ser. No. 12/091,359, filed Apr. 24, 2008 and published Oct. 1, 2009 as U.S. Publication No. US-2009-0244361, and/or Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; and/or 7,720,580, and/or U.S. patent application Ser. No. 10/534,632, filed May 11, 2005, now U.S. Pat. No. 7,965,336; and/or PCT Application No. PCT/US2008/076022, filed Sep. 11, 2008 and published Mar. 19, 2009 as International Publication No. WO/2009/036176, and/or PCT Application No. PCT/US2008/078700, filed Oct. 3, 2008 and published Apr. 9, 2009 as International Publication No. WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,720,580; 7,038,577; 5,929,786 and/or 5,786,772, and/or U.S. patent application Ser. No. 11/239,980, filed Sep. 30, 2005, now U.S. Pat. No. 7,881,496, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149; and/or U.S. patent application Ser. No. 11/226,628, filed Sep. 14, 2005 and published Mar. 23, 2006 as U.S. Publication No. US-2006-0061008, and/or Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in PCT Application No. PCT/US2011/056295, filed Oct. 14, 2011 and published Apr. 19, 2012 as International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described International Publication Nos. WO 2010/099416; WO 2011/028686; WO 2012/075250; WO 2013/019795; WO 2012/075250; WO 2012/145822; WO 2013/081985; WO 2013/086249; and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent application Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

While the above description constitutes a plurality of embodiments of the present invention, it will be appreciated that the present invention is susceptible to further modification and change without departing from the fair meaning of the accompanying claims.

1. A camera and switch assembly for a vehicular vision system, said camera and switch assembly comprising:
a housing configured for attachment at a door of a vehicle;
a circuit board disposed in said housing;
an image sensor disposed at said circuit board;
a handle switch disposed at said housing, wherein said handle switch is operable to actuate a latch of the door when actuated by a user;
circuitry disposed at said circuit board, said circuitry comprising sensor circuitry associated with said image sensor and switch circuitry associated with said handle switch; and
wherein, when said housing is attached at a door of a vehicle, a wire of the vehicle is electrically connected to said sensor circuitry associated with said image sensor and to said switch circuitry associated with said handle switch.

2. The camera and switch assembly of claim 1, wherein said housing is configured for attachment at a rear portion of the vehicle and wherein said handle switch is operable to open a rear door of the vehicle and wherein said image sensor comprises a rearward viewing image sensor.

3. The camera and switch assembly of claim 2, comprising a plate element at a rear portion of said housing, and wherein said handle switch and a lens element of said image sensor are disposed at said plate element.

4. The camera and switch assembly of claim 1, comprising a plate element at said housing, and wherein said handle switch and a lens element of said image sensor are disposed at said plate element.

5. The camera and switch assembly of claim 4, comprising an electrical connector for electrically connecting the wire of the vehicle to said sensor circuitry and said switch circuitry.

6. The camera and switch assembly of claim 5, wherein said electrical connector is disposed at said housing generally opposite said plate element.

7. The camera and switch assembly of claim 5, wherein said electrical connector is electrically connected to said circuit board, and wherein said electrical connector is configured to engage an electrical connector of the wire of the vehicle.

8. The camera and switch assembly of claim 1, comprising an electrical connector for electrically connecting the wire of the vehicle to said sensor circuitry and said switch circuitry.

9. The camera and switch assembly of claim 8, wherein said electrical connector is electrically connected to said circuit board, and wherein said electrical connector is configured to engage an electrical connector of the wire of the vehicle.

10. The camera and switch assembly of claim 1, comprising bus interface associated with at least said image sensor.

11. The camera and switch assembly of claim 1, comprising at least one other sensor comprising at least one of (i) a second image sensor, (ii) a LIDAR sensor, (iii) a time of flight (TOF) sensor, (iv) a structure light emitter and (v) a RADAR sensor.

12. The camera and switch assembly of claim 1, wherein said handle and switch assembly comprises a unitary module is attachable at the door of the vehicle as a unit.

13. The camera and switch assembly of claim 12, wherein said unitary module is substantially water impervious.

14. A camera and switch assembly for a vehicular vision system, said camera and switch assembly comprising:
a housing configured for attachment at a rear portion of a vehicle;
a circuit board disposed in said housing;
an image sensor disposed at said circuit board, wherein said image sensor comprises a rearward viewing image sensor that views rearward of the vehicle when said housing is attached at the rear portion of the vehicle;
a handle switch disposed at said housing, wherein said handle switch is operable to actuate a latch of a rear door of the vehicle when actuated by a user;
a plate element at a rear portion of said housing, and wherein said handle switch and a lens element of said image sensor are disposed at said plate element;
circuitry disposed at said circuit board, said circuitry comprising sensor circuitry associated with said image sensor and switch circuitry associated with said handle switch;
wherein, when said housing is attached at a door of a vehicle, a wire of the vehicle is electrically connected to said sensor circuitry associated with said image sensor and to said switch circuitry associated with said handle switch; and
wherein said handle and switch assembly comprises a unitary module is attachable at the door of the vehicle as a unit, and wherein said unitary module is substantially water impervious.

15. The camera and switch assembly of claim 14, comprising an electrical connector for electrically connecting the wire of the vehicle to said sensor circuitry and said switch circuitry.

16. The camera and switch assembly of claim 15, wherein said electrical connector is disposed at said housing generally opposite said plate element.

17. The camera and switch assembly of claim 15, wherein said electrical connector is electrically connected to said circuit board, and wherein said electrical connector is configured to engage an electrical connector of the wire of the vehicle.

18. The camera and switch assembly of claim 14, comprising at least one of (i) a bus interface associated with at least said image sensor, (ii) a second image sensor, (iii) a LIDAR sensor, (iv) a time of flight (TOF) sensor, (v) a structure light emitter and (vi) a RADAR sensor.
